(19) United States
(12) Patent Application Publication
(10) Pub. No.: US 2005/0109801 A1
(43) Pub. Date: May 26, 2005

(54) Closure mechanism

(76) Inventor: Stuart Mayston, Suffolk (GB)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/971,481

(22) Filed: Oct. 22, 2004

(30) Foreign Application Priority Data
Oct. 24, 2003 (GB) GB 0324812.7

(51) Int. Cl. B67B 5/00; B67D 5/06; B67D 5/32; B67D 5/33; B67D 5/378; B67D 3/00

(52) U.S. Cl. 222/536

(57) ABSTRACT

A closure mechanism for a container said closure mechanism comprising a main body (2) either forming part of the container or adapted for attachment thereto. The mechanism has a plunger (3) movably mounted on the main body, and a dispenser (4) mounted on the main body for movement between a closed position and an open position. At the closed position a flow path for product within the container is obstructed and at the open position the product may be dispensed from the container through the flow path. The mechanism further comprising a mechanical linkage (25) that links the movement of the plunger (3) to the dispenser (4) such that the movement of one cause a movement of the other. The flow path is preferably formed within the dispenser, and the mechanical linkage is preferably a lever.

The present invention relates to a closure mechanism, and in particular to a closure mechanism adapted for attachment to or integral formation with the neck or opening of a container. It also relates to a closure or a container incorporating such a closure mechanism.

Mechanisms for selectively opening and sealing containers may be generally referred to as closures, and these may be moved from closed positions where the container is sealed to open positions where the contents of the container may be dispensed. A variety of closures for containers, particularly containers adapted to contain flowable material such as cosmetic products and foodstuffs, are already available. Such closures usually comprise a main portion, which may be part of the container or which may be attached thereto, to which main portion a cap is hinged, push-fitted or screw-fitted so that it may be opened and closed to selectively allow the contents of the container to be dispensed. Such closures are widely known and have been so for a considerable period of time.

In addition to these, so-called disc-top or toggle type closures have also been provided. These generally comprise a single-piece lid which pivots through a relatively small angle between an open and a closed position. At the open position a dispensing spout in the lid is uncovered such that liquid within the container may be dispensed therethrough. However, whilst this type of closure offers advantages over and above the simple flip or screw-top closures that preceded them, there are still significant mechanical and aesthetic limitations to this type of design.

It is therefore an aim of the present invention to provide an improved closure mechanism that is easy to operate and manufacture. It is a further aim to provide a closure mechanism that may optionally provide a tamper-evident mechanism.

Therefore according to the present invention there is provided a closure mechanism for a container said closure mechanism comprising a main body forming part of the container or adapted for attachment thereto, a plunger mounted for movement on the main body, a dispenser mounted on the main body for movement between a closed position whereat a flow path for product within the container is obstructed and an open position whereat the product may be dispensed from the container through the flow path, and a mechanical linkage that links the movement of the plunger to the dispenser such that the movement of one cause a corresponding movement of the other.

It is possible that the dispenser may be adapted to cover and thus obstruct the product flow path, such that movement of the dispenser causes this obstruction to be removed or replaced as appropriate. However it is particularly preferred that the dispenser actually defines at least a part of the flow path for the product such that the product actually flows through the dispenser before its discharge.

The movement of the plunger and dispenser would, apart from the linkage, be independent, and could be in any suitable arrangement. The movement of each is preferably linear, and preferably also is a sliding movement in the same plane as each other. In this way the axis of movement of each are generally parallel. It is also preferred that the movements of the plunger and dispenser are opposite to each other.

The mechanical linkage used to inter-connect the movement of the separate plunger and the dispenser may take a variety of forms, as long as one moves in response to the movement of the other and vice versa. A simple cog wheel, pinion and racks or other mechanism could be used, but it has proved highly advantageous to employ a lever as the linkage. A simple first order lever is particularly appropriate as the movement of one of the dispenser and plunger can be coupled to an opposite movement of the other component. For example, one arm of the lever is coupled to the movement of the plunger such that depression of the plunger causes that arm to move in one direction and hence the lever to pivot about its effective fulcrum. This in turn causes an opposite or consequential movement of the other arm and this can be coupled to the dispenser to cause appropriate movement.

The closure mechanism can, as stated, be part of a container or be incorporated in a separate closure that may be connected to the opening or neck of a separate container. In most packaging situations the container would be made, printed and filled before the closure in connected thereto using standard methods such as screw threads, push fit etc. The closure incorporating the closure mechanism would then be used by a purchaser selectively to dispense the contained-product by opening and closing the flow path.

The main body may define an upstanding outer sleeve within which the plunger and dispenser are mounted. This outer sleeve may serve not only to guide the movement of the dispenser and plunger but also conceals the working parts to both protect them from damage and improve the visual appearance of the end product.

When the plunger and dispenser are in their closed positions, the upper surfaces thereof may preferably be generally co-planar, and they may be approximately level with the uppermost edge of the main body. If present the sleeve will generally define the uppermost edge of the main body. In this type of embodiment, the depression of the plunger would then raise the dispenser causing a difference in levels of the upper surfaces when in the open position.

To move the plunger from its closed position will generally require its depression toward the main body or into the sleeve where present. However if the upper edge of the sleeve is generally level with the upper surface of the plunger, the manual depression of the plunger could be impeded, especially where the plunger is depressed by the finger of a hand that is holding the container, as this finger would normally extend upwardly from below and then extend around the edge of the sleeve. Therefore it is preferred that a portion of the upstanding sleeve adjacent the plunger is lower than the remainder thereof to form a finger cut-out that assists in manual operation of the plunger.

As mentioned above a lever is highly preferred as the linkage mechanism, and the lever needs to be mounted for pivoting to couple appropriately the movement of the plunger and dispenser. The lever may be mounted on the main body for pivoting movement and is directly or indirectly mechanically coupled to the plunger and dispenser. If directly coupled the lever would bear on appropriate parts of both the dispenser and plunger. If indirectly coupled this coupling would be through one or more intermediate link.

The plunger and dispenser move from an open position to a closed position, either one of which is desired for normal operation. However, between a fully open position and a fully closed position is an intermediate state in which the flow path may be only partially open such that the container is neither fully sealed (so that leaks can occur) nor completely open (such that correct flow is obstructed). To mitigate this problem it is highly preferred that the mechanical linkage includes a bi-stable toggle mechanism that urges the plunger and dispenser to adopt either a fully open or fully closed position. The range of movement in between would thereby be limited to a swift transfer from one state to the other.

When the mechanical linkage is a lever, the toggle mechanism may take the form of an obstruction (usually provided on the main body) and a cooperating resiliently deformable abutment, possibly on a bowspring, on the lever (or indeed vice versa). The abutment on the lever must be deformed against the force of the bowspring to pass over the obstruction during pivoting of the lever from one position. The abutment returns due to the resilience of the bowspring to its original position once it has passed the obstruction and the lever has reached its other position.

In use a sufficient force must be applied to the plunger to deform the abutment from behind the obstruction, such that once the obstruction is cleared the reduction in resistance means that the now ample force swiftly moves the plunger lever and dispenser to the open position. Once at the open position the abutment resumes its normal position, but on the other side of the abutment. The toggle mechanism is now ready for the reverse transition from the open configuration to the closed. Alternative toggle mechanisms may be employed.

The lever may also be made active by appropriate design. This could be used such that in any cycle of movement the initial motion of the plunger and dispenser past a certain threshold point would then cause an assisted completion of that cycle of movement by force stored in the lever during the initial motion up to the threshold. This could have the advantage of overcoming initial dry resistance that occurs before product has lubricated the moving parts. A further advantage of this feature would be the provision of an obvious tactile or aubible sensation such as a “click” to indicate opening or closure.

The main body may define a tube that is in communication with the inside of the container and with the flow path defined within the dispenser such that the contents of the container may flow therethrough. The dispenser may have a seal that engages with the outer end of this tube when in the closed position to close the container. This tube may have a generally linear exterior and the dispenser may include a sleeve that is adapted to fit therearound and which forms part of the flow passage within the dispenser. This fit should be slidable yet seal sufficiently to prevent leakage of the contained product, the sliding of the sleeve around the tube being used to guide the movement of the dispenser.

The plunger may also include a shaft, the plunger being mounted on the main body by means of slidable engagement of the shaft in a closed second tube provided on the main body. The sliding of the plunger and dispenser may be generally co-axial, co-planar or in different planes/axes of movement.

The main body, plunger and dispenser may be provided with cooperating abutments that limit the range of movement of the plunger and dispenser with respect to the main body and each other.

A closure incorporating the closure mechanism may be formed in any number of shapes. It a particular embodiment it is preferred that in plan view the upper surfaces of the plunger and dispenser together define a shape that makes up the majority of the plan area of the closure and generally matches the overall plan shape thereof. For example if the main body is generally circular in plan view, the upper surfaces of the plunger and dispenser could together define a circle in plan view and fit within a tubular upstanding outer sleeve.

In many embodiments the edge of the dispenser needs to be located near the edge of the closure so that the discharge orifice is conveniently located.

A preferred aim of the present invention is to provide a closure of the type already defined but with a tamper indicating mechanism, as this has not proved readily possible on the relevant prior type of closure mechanism. One particularly convenient way of achieving this is by incorporating a frangible strip or strips that join the plunger and dispenser, which strip(s) ruptures on first relative movement of the plunger and dispenser from the closed position. Rupture of these may require an extra force, so that the frangible strips can provide both tactile and visual evidence of tampering. The plunger may, as discussed in more detail later, be formed as a single moulding with the frangible strips provided integrally formed therebetween.

It is also highly preferred that the dispenser defines a discharge opening at the outer end of the flow passage, which discharge opening is covered by a part of the main body when the dispenser is in the closed position, but is opened when the dispenser is moved to the open position. The discharge opening is preferably in the side of the dispenser and is preferably covered by a part of the upstanding outer sleeve when in the closed position. The one advantage of this is that product that has passed into the dispenser past any seal will not leak therefrom between uses because the discharge opening is closed simultaneously with any sealing of the flow path. There are other advantages such as slowing the degradation of the product that has passed the seal.

It is preferred that a protruding lip is provided around the discharge opening. This lip forms a seal between the dispenser and the outer sleeve when in the closed position such that partially dispensed product (i.e. that within the dispenser that has passed the main seal but not exited the discharge opening) does not degrade. A further advantage of this protruding lip is that its lower part below the discharge opening will tend to bridge any gap between the dispenser and the outer sleeve when in the open position such that ingress of the product therebetween is reduced or prevented. Furthermore the movement of the lip from behind the outer sleeve also provides an audio and/or tactile indication that the dispenser has reached its open position.

The plunger, linkage and dispenser can be linked in many combinations and many orientations. However when for use on most currently available containers, it is preferred that they are mounted on a neck at one end of a container with an elongate axis and the axes of movement of the dispenser and plunger are generally parallel with the elongate axis of the container and each other.

The main body may be adapted for attachment to a separate container and may be provided with attachment means to permit that connection. These attachment means may take a variety of forms including screw threads, push fittings and other mechanisms.

According to the present invention there is also provided a closure and a container each incorporating a closure mechanism as hereinbefore described.

It has been found that the present invention offers many advantages over the existing designs. In addition to the provision of simple mechanism for tamper indication, it also allows the main sealing parts to have rectilinear engagement thus improving sealing, and it further allows easy control of the relative leverage of the two parts and the range of relative movement.

By way of example only, an embodiment of closure of this invention will now be described in detail, reference being made to the accompanying drawings in which:—

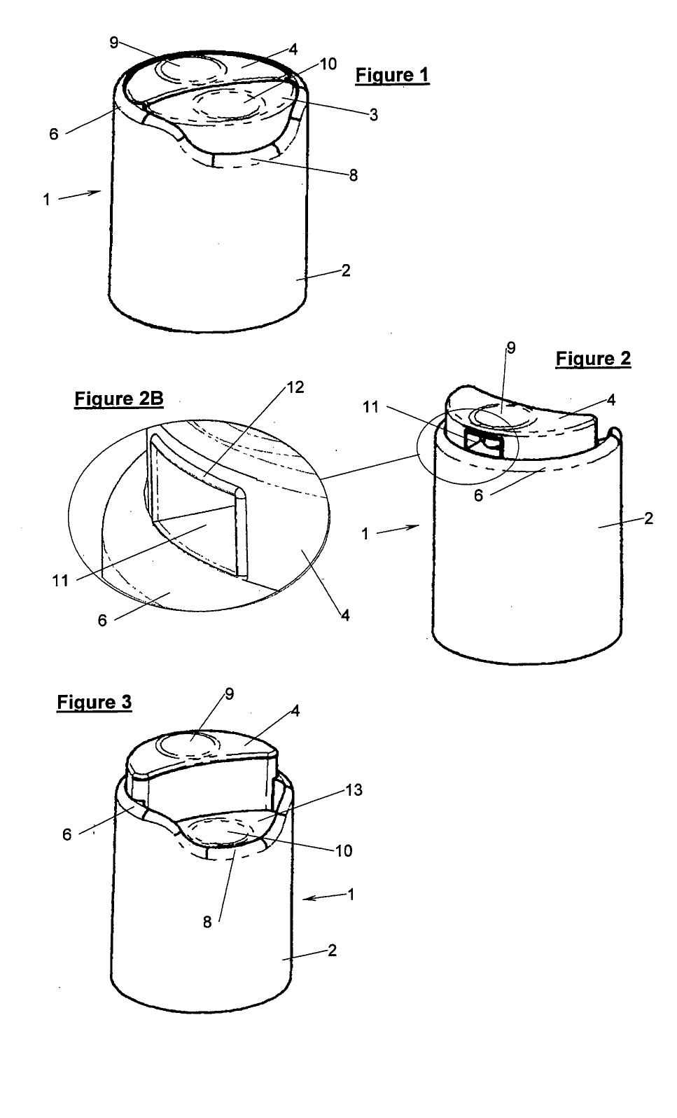

FIG. 1 is a perspective view of one embodiment of closure according to the present invention in the closed configuration;

FIG. 2 is an opposite perspective view to that shown in FIG. 1 of the same embodiment, but in the open configuration;

FIG. 2B is an enlarged detail of the discharge opening (shown in slightly different perspective;

FIG. 3 is an opposite perspective view to that shown in FIG. 2;

FIG. 4 is a plan view of the embodiment;

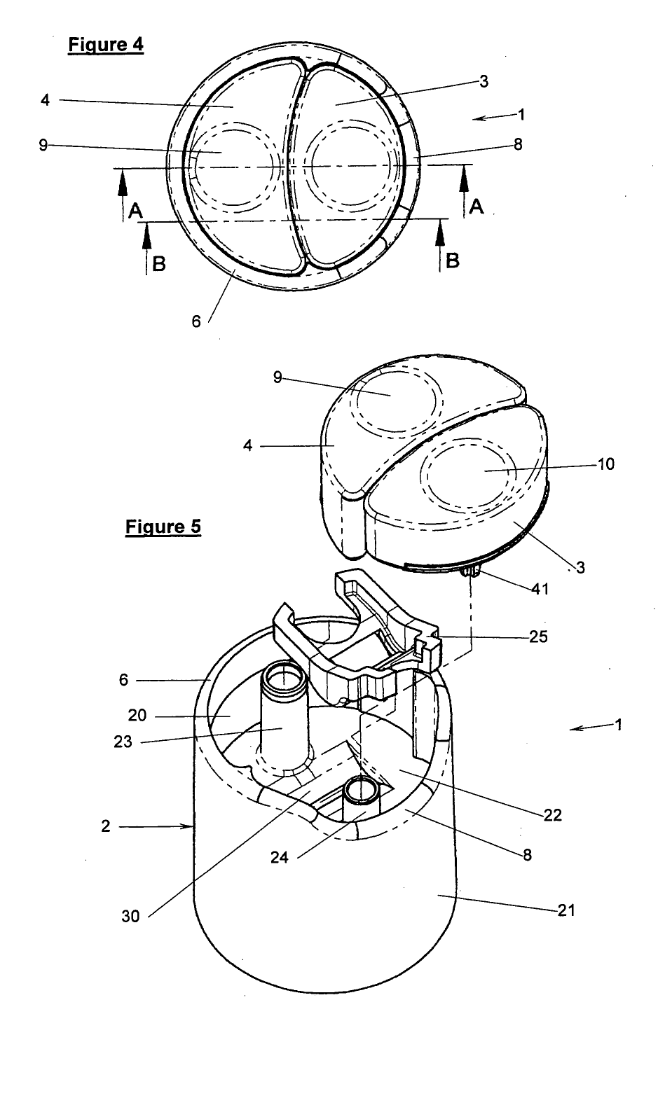

FIG. 5 is a perspective view of the embodiment showing the constituent components separated for ease of reference;

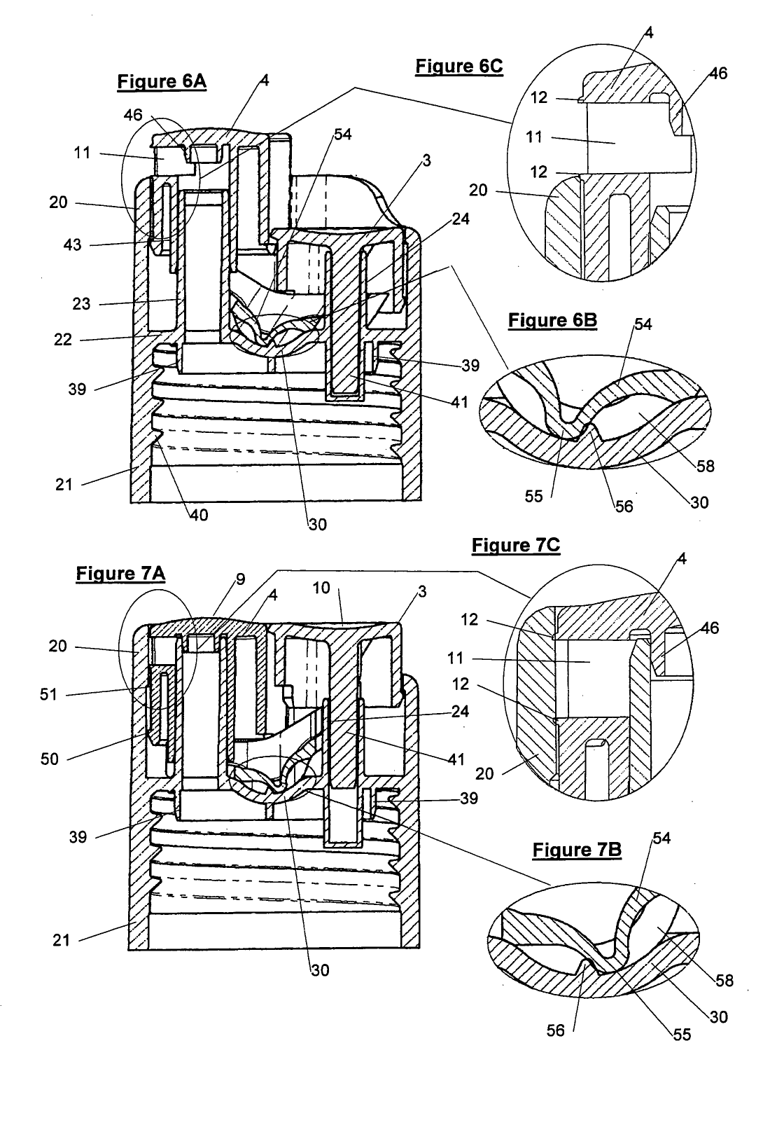

FIG. 6A is a cross-section through the embodiment of FIG. 4 along line A-A in an open position;

FIG. 6B shows an enlarged detail from FIG. 6A;

FIG. 6C shows a different enlarged detail from FIG. 6A;

FIG. 7A is a cross-section along A-A in FIG. 4 but in the closed position;

FIG. 7B is an enlarged detail from FIG. 7A, and is similar to FIG. 6B;

FIG. 7C is a different enlarged detail from FIG. 7A, and is similar to FIG. 6C;

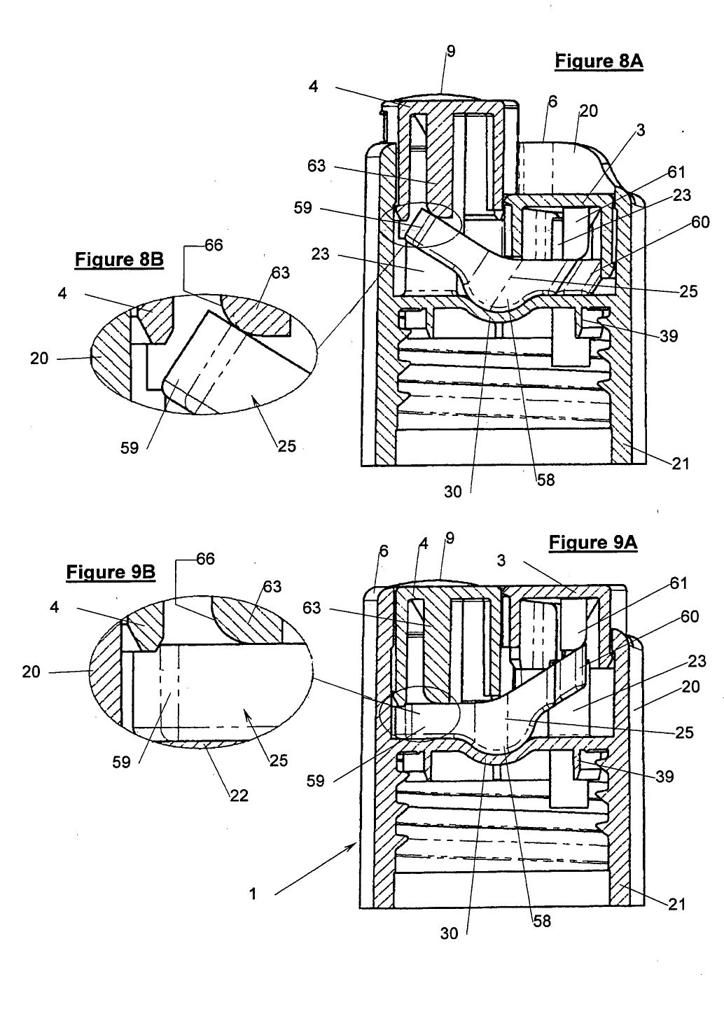

FIG. 8A is a vertical section along line B-B of FIG. 4, with the closure in an open position;

FIG. 8B is an enlarged detail from FIG. 8A;

FIG. 9A is a vertical section along line B-B similar to FIG. 8A but showing the container in a closed configuration;

FIG. 9B is an enlarged detail from FIG. 9A and is of the same region shown in the detail of FIG. 8B;

FIG. 10 is an underside view of the plunger/dispenser component;

FIG. 11 is a vertical section through the component of FIG. 10 along line L-L;

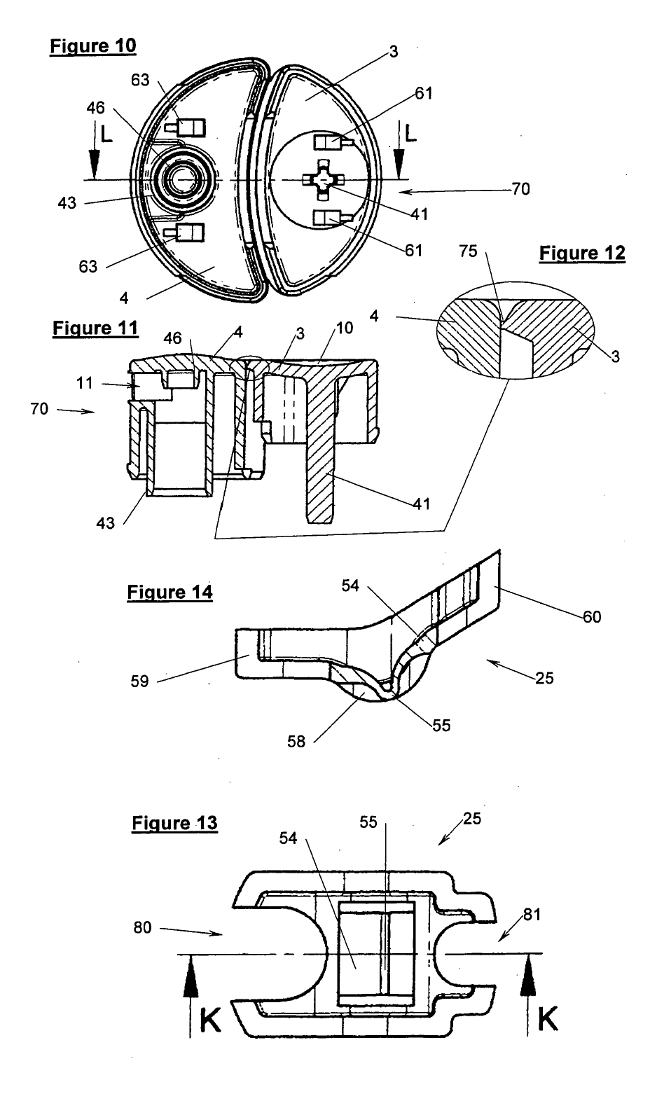

FIG. 12 is an enlarged detail taken from FIG. 11;

FIG. 13 is a plan view of the lever component of the previous representations;

FIG. 14 is a cross-section through the lever component along line K-K;

FIG. 15 is a perspective view of an alternative second embodiment of lever;

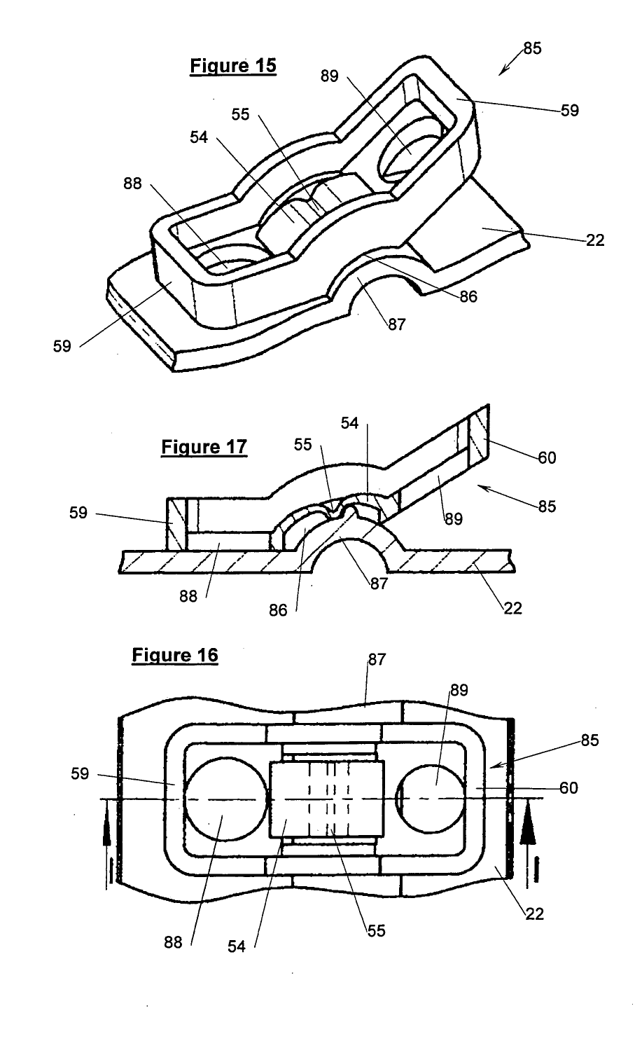

FIG. 16 is a plan view of the second embodiment of lever shown in FIG. 15;

FIG. 17 is a vertical section through the second embodiment of lever shown in FIG. 16 and taken along line I-I;

FIG. 18 is a perspective view of an alternative third embodiment of lever;

FIG. 19 is a plan view of the third embodiment of lever shown in FIG. 18; and

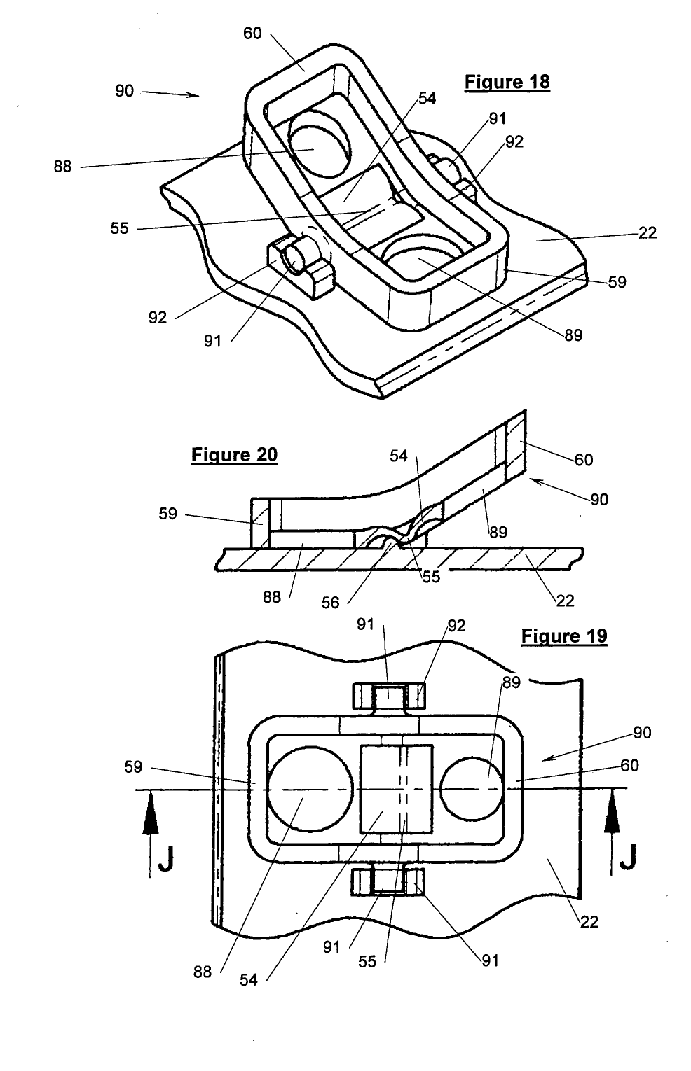

FIG. 20 is a vertical section along line J-J of the embodiment of lever component shown in FIGS. 18 and 19.

Referring initially to FIGS. 1, 2, 2B and 3, there is shown an embodiment of closure generally indicated 1, which incorporates a closure mechanism according to the present invention. The closure 1 comprises a generally cylindrical main body 2 which is adapted for attachment to a container (not shown). A plunger 3 and a dispenser 4 are mounted at the upper end of the main body 2 for reciprocal linear movement. Downward movement of the plunger 3 causes, by means of a lever mechanism (not shown in FIGS. 1-3 but visible in later Figures), the dispenser 4 to rise upwards. The upper edge 6 of the main body 2 is provided with a cut-out portion 8 adjacent the plunger 3. This eases the depression of the plunger by the finger of a user. To further assist this manipulation, the upper surface of the plunger and the upper surface of the dispenser 4 are respectively provided with a depression 10 and a raised area 9 to ensure correct alignment and orientation of the pushing force, as well as a tactile differentiation between them. As will be described further and in greater detail below, the dispenser 4 is provided with a discharge opening in the form of an outlet 11 through which flowable product contained within the container may be dispensed when the plunger and dispenser are moved to an open position by depression of the plunger 3. As best seen in FIG. 2B a protruding lip 12 is formed around the outlet 11.

FIG. 4 shows a plan view of the closure 1 and indicates lines A-A and B-B through which cross-sections of the device are shown in FIGS. 6 to 9. However FIG. 5 shows the components of the dispenser separated such that the internal configuration may more readily be discerned.

As can be seen from FIG. 5 the main body includes an upper sleeve 20, the top edge of which defines the upper edge 6 of the main body. It further includes a lower skirt 21 in use for connecting the closure to a container. At the lower end of the sleeve 20, the main body defines a base 22 and upstanding therefrom first and second columns 23 and 24 that are hollow. A lever 25 locates on the base 22 between the first and second columns 23 and 24 and is adapted for pivoting movement. The lever 25 having a curved lower region 25 that locates in a matching depression 30 on the base 22. The dispenser 4 and plunger 3 are located above the lever 25 and within the sleeve 20. The dispenser 4 locates for vertical sliding movement on the first column 23, the hollow centre of that column also defining a flow path from the container. The plunger 3 is mounted for vertical sliding movement on the second column 24 and each of the plunger and the dispenser are mechanically coupled through the lever 25. Downward movement of one of the plunger 3 or the dispenser 4 causes a corresponding upward movement of the other through the mechanism of the lever, one of the components pressing downwards on one side of the lever 25 such that it pivots and forces the opposed side of the lever upwards to move the other component upwards as well.

As can clearly be seen in FIG. 6A, the lower half of the main body 2 is in the form of a lower skirt 21 which is adapted, in this embodiment by provision of a thread mechanism 40 for attachment to the neck of a container (not shown). An annular seal 39 is also provided extending downwardly from the base 22 to engage and seal in the neck of a container to which the closure 1 is attached. The plunger 3 as shown in FIGS. 6A and 7A is mounted on the second column 24 for vertical sliding movement. The plunger has a spigot 41 which locates within the hollow second column 24. The lower end of the second column 24 is closed so that it is not in communication with the contents of the container. In contrast the first column 23 which is also hollow is open both at its lower end and its upper end and forms part of a flow passage from the container. The dispenser 4 includes a tube portion 43 which sealingly but slidably locates around the first column 23 to guide the movement of the dispenser 4. The tube 43 also defines a flow passage leading from the upper end of the first column 23 to the outlet 11 provided on the side of the dispenser 4. When the closure 1 is in the closed position, in this embodiment the upper surfaces of the plunger 3 and dispenser 4 are generally co-planar and align with the upper edge 6 of the main body 2. At this position the dispenser 4 seals the upper end of the first column 23 by engagement of a plug seal 46 provided on the dispenser 4 into the upper end of the column 23. This prevents liquid flow from within the container as the only exit route would be through the first column 23 which of course is now sealed by the plug seal 46.

During normal operation, and starting from the closed configuration as shown in FIGS. 7A and 7B, the container may be opened by downward movement of the plunger 3. This downward movement forces pivoting of the lever 25 (as better shown in FIGS. 8 and 9) such that it exerts an opposite upward force on the dispenser 4. The upward movement of the dispenser 4 caused by this force disengages the plug seal 46 from the upper end of the first column 23 as well as uncovering the outlet 11 which, in the closed configuration, is covered by an upper part of the sleeve 20. Once the plunger 3 is moved fully to its open position, further movement is prevented by the abutment of the lower end of the spigot 41 against the lower end of the tube within the second column 24. At this point the dispenser 4 is also at its upper limit of movement and the flow passage is fully opened such that liquid within the container may be dispensed. To limit the range of upward movement of the dispenser 4, co-operating abutments 50 and 51 are provided on the dispenser 4 and on the sleeve 20. Similar co-operating abutments are also provided on the plunger 3 and main body 2.

As best show in the enlarge details of the outlet 11 shown in FIGS. 6C and 7C, a protruding lip 12 is provided all around the outlet 11. This lip 12, when the dispenser 4 is in the closed position as shown in FIG. 7C, forms an air tight seal that prevents degradation of any product that has passed the plug seal 46 but is still within the dispenser 4. Also the lower part of the lip 12 tends to bridge any gap between the sleeve 20 and the dispenser 4 when in the open position (shown in FIG. 6C).

The lever 25 is provided with a bi-stable toggle mechanism such that it is urged to adopt either the fully open or fully closed positions. As can best be seen in FIGS. 13 and 14, this bi-stable toggle mechanism takes the form of a resiliently deformable bowspring 54 with a ridge 55 which during pivoting movement of the lever 25 must move past an obstruction 56 formed in the curved depression 30 on the base 22 in which the lever 25 locates. In the fully closed configuration as shown in FIG. 7B, the ridge 55 locates to the right-hand side (as viewed in this drawing) of the obstruction 56. On downward movement of the plunger and consequent pivoting of the lever 25, the ridge is deformed upwards against the force of the bowspring 54 such that it may pass over the obstruction 56. Once it has moved far enough it will resume its normal shape and locate on the left-hand side of the obstruction in the fully open configuration (as best shown in FIG. 6B).

FIGS. 8 and 9 show similar open and closed configurations of the closure in a cross-section along line B-B in FIG. 4. These representations show particularly well the interengagement of the plunger 3 with the lever 25 as well as the dispenser 4 with the lever 25. As can be seen the lever 25 has a curved lower surface which locates within the appropriately curved depression 30 formed in the base 22. In the closed configuration shown in FIG. 9A the plunger-engaging side 60 of the lever is uppermost and engages with a plunger stantion 61 extending downwards from the plunger 3. On downward movement of the plunger 3 the stantion 61 depresses the plunger side 60 of the lever 25 and causes the lever as a whole to rotate around a pivot point (or fulcrum) defined by the curvature of curved depression 30 and the curved lower surface 58 of the lever. The dispenser-engaging side 59 of the lever 22 is, in the closed configuration shown in FIG. 9A generally lying against the base 22. The upper side of that region of the lever engages with a dispenser stantion 63 such that on upward movement of the plunger side 59 of the lever 25 (when the lever pivots) that movement may be translated into an upward force to move that dispenser.

As can be seen, the lower ends of both the plunger stantion 61 and dispenser stantion 63 are provided with curved contact surfaces 65, 66 to ensure that the contact between the pivoting lever 25 and the stantions remains at essentially 90° during movement. A contact surface 66 of the dispenser stantion 63 in contact with the plunger side of the lever 25 is best shown in both the open and closed configurations in FIGS. 8B and 9B.

FIG. 10 shows an underside view of a combined plunger/dispenser component 70 which is manufactured as a single moulding and includes the plunger 3 and dispenser 4, which are separated on first use to provide a tamper indicator. This shows that there are two plunger stantions 61 provided either side of the spigot 41. Similarly there are two dispenser stantions 63 provided either side of the dispenser tube 43. In FIG. 11 the two components of FIG. 10 are shown in cross-section along line L-L. This view is similar to that shown in FIG. 7A. However, in this view the two components are joined as detailed in FIG. 12. The plunger 3 and dispenser 4 are joined by a frangible connection such that on depression of the plunger with a suitable force for the first time, this frangible connection is ruptured thereby providing evidence of tampering. The plunger 3 and dispenser 4 may be formed as a single moulding, with the frangible strip in place such that only after first activation of the system will the two components be separated thereby providing a convenient mechanism to indicate tampering.

The lever 25 is shown in FIGS. 13 and 14 in plan and cross-section. As can be seen the lower portion of the lever has a curved surface 58 such that the lever 25 may conveniently pivot when located in the appropriately curved depression 30 described above. Further between the two curved surfaces 58 (the two being required to ensure balance) there is provided a deformable ridge 55 on a bowspring 54 which provides a bi-stable toggle mechanism as discussed above. As can be seen in FIG. 13 the lever is provided with a first cut away section 80 such that it locates around the first column 23, and a second cut away section 81 such that it locates around the second column 24.

FIGS. 15, 16 and 17 show an alternative embodiment of lever mechanism (generally indicated 85) which is similar to that described above, and where possible like reference numerals will be used. In this embodiment however the lower surface is provided with a concave portion 86 that is adapted to locate on a convex region 87 of the base. A similar deformable bi-stable toggle mechanism is provided. Instead of cut away sections this lever mechanism is provided with apertures 88, 89 that locate around the columns 23, 24 and are suitably proportioned such that the pivoting movement of the lever does not bring the edges of those apertures 88, 89 into contact with the columns.

FIGS. 18, 19 and 20 show a third possible embodiment of lever mechanism (generally indicated 90) wherein the lever 90 is mounted for pivoting by spigots 91 extending laterally therefrom which located upon bearings 92 provided on the base. Pivoting of the lever occurs through rotation of the spigots 91 within the bearings 92, but the toggle mechanism remains essentially the same as before. Clearly many alternative arrangements of lever or other mechanical linkage can be employed without departing from the scope of this invention.

1. A closure mechanism for a container said closure mechanism comprising a main body either forming part of the container or adapted for attachment thereto, a plunger mounted for movement on the main body, a dispenser mounted on the main body for movement between a closed position whereat a flow path for product within the container is obstructed and an open position whereat the product may be dispensed from the container through the flow path, and a mechanical linkage that links the movement of the plunger to the dispenser such that the movement of one cause a corresponding movement of the other.

2. A closure mechanism as claimed in claim 1, wherein the dispenser defines at least a part of the flow path for product within the container.

3. A closure mechanism as claimed in claim 1, wherein, the mechanical linkage is a lever.

4. A closure mechanism as claimed in claim 1, wherein the main body includes an upstanding sleeve within which the plunger and dispenser are mounted.

5. A closure mechanism as claimed in claim 1 in which the upper surfaces of the plunger and dispenser are generally co-planar when the dispenser is in its closed position.

6. A closure mechanism as claimed in claim 1, wherein when the dispenser is in its closed position the upper surfaces of the plunger and dispenser are approximately level with an uppermost edge of the main body.

7. A closure mechanism as claimed in claim 1, wherein a portion of the upstanding sleeve adjacent the plunger is lower than the remainder thereof to form a finger cut-out that assists in manual operation of the plunger.

8. A closure mechanism as claimed in claim 1, wherein the lever is mounted on the main body for pivoting movement and is directly or indirectly mechanically coupled to the plunger and dispenser.

9. A closure mechanism as claimed in claim 1 wherein the mechanical linkage includes a toggle mechanism that urges the plunger and dispenser to adopt a fully open or fully closed position.

10. A closure mechanism as claimed in 1, wherein the mechanical linkage is a lever and the toggle mechanism takes the form of an obstruction provided on the main body and a cooperating resiliently deformable bowspring on the lever that must be deformed to pass over the obstruction during pivoting of the lever.

11. A closure mechanism as claimed in claim 1 wherein the main body defines a tube that is in communication with the inside of the container and the dispenser has a seal that engages with the outer end of this tube when in the closed position.

12. A closure mechanism as claimed in claim 2 wherein the main body defines a tube that is in communication with the inside of the container and the flow path within the dispenser, the dispenser having a seal that engages with the outer end of this tube when in the closed position.

13. A closure mechanism as claimed in claim 1, wherein the tube is generally linear and the dispenser includes a sleeve that fits therearound and forms part of the flow passage within the dispenser, the sleeve being a snug yet sliding fit around the tube and the movement of the dispenser being guided thereby.

14. A closure mechanism as claimed in claim 1 wherein the plunger includes a shaft, the plunger being mounted on the main body by means of slidable engagement of the shaft in a closed second tube provided on the main body.

15. A closure mechanism as claimed in claim 1 wherein the main body, plunger and dispenser are provided with cooperating abutments that limit the range of movement of the plunger and dispenser with respect to each other.

16. A closure mechanism as claimed in claim 1 wherein the main body is tubular, and is generally circular in plan view, and the upper surfaces of the plunger and dispenser together define a circle in plan view and fit within a tubular upstanding sleeve forming part of the main body.

17. A closure mechanism as claimed in claim 1, wherein the plunger and dispenser are joined by a frangible strip that ruptures on first relative movement of the plunger and dispenser from the closed position to thereby provide evidence of tampering.

18. A closure mechanism as claimed in claim 1, wherein the dispenser defines a discharge opening at the outer end of the flow path, which discharge opening is in the side of the dispenser and is covered by a part of the main body when the dispenser is in the closed position, but is uncovered when the dispenser is moved to the open position.

19. A closure mechanism as claimed in claim 1, wherein the axes of movement of the dispenser and plunger are generally parallel.

20. A closure mechanism as claimed in claim 1, wherein the main body is provided with attachment means to permit attachment to a separate container.

21. A container incorporating a closure mechanism as claimed claim 1.

22. A closure incorporating a closure mechanism as claimed in claim 1.
